(19) United States
(12) Patent Application Publication
(10) Pub. No.: US 2024/0276293 A1
(43) Pub. Date: Aug. 15, 2024

(54) First Node, Second Node, and Methods Performed Thereby for Handling Traffic From the Second Node

(71) Applicant: Telefonaktiebolaget LM Ericsson (publ), Stockholm (SE)

(72) Inventor: Maria Cruz Bartolome Rodrigo, Madrid (ES)

(21) Appl. No.: 18/564,717

(22) PCT Filed: Aug. 19, 2021
(86) PCT No.: PCT/EP2021/073040

§ 371 Date: Nov. 28, 2023

(30) Foreign Application Priority Data
Jun. 7, 2021 (EP) 21382505.2

(51) Int. Cl. H04W 28/02

(52) U.S. Cl. CPC H04W 28/0289; H04W 28/0284

(57) ABSTRACT

A computer-implemented method performed by a first node (111). The method is for handling traffic from a second node (112). The first node (111) and the second node (112) operate in a communications network (100). The first node (111) sends (305) a message to the second node (112). The message comprises a request to abate traffic from the second node (112) to the first node (111). The message further comprises an indication identifying the second node (112).

### TECHNICAL FIELD

The present disclosure relates generally to a first node and methods performed thereby for handling traffic from a second node. The present disclosure also relates generally to a second node, and methods performed thereby for handling the traffic from the second node.

### BACKGROUND

Computer systems in a communications network may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the RAN, radio network node or Transmission Point (TP), for example, an access node such as a Base Station (BS), e.g. a Radio Base Station (RBS), which sometimes may be referred to as e.g., evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also be a non-cellular system, comprising network nodes which may serve receiving nodes, such as user equipments, with serving beams.

The standardization organization 3GPP is currently in the process of specifying a New Radio Interface called NR or 5G-UTRA, as well as a Fifth Generation (5G) Packet Core Network, which may be referred to as 5G Core Network, abbreviated as 5GC.

A 3GPP system comprising a 5G Access Network (AN), a 5G Core Network and a UE may be referred to as a 5G system.

Overload control may be understood as a mechanism that enables a node in a network to reduce its incoming signalling load after it may have become overloaded, by instructing other nodes sending traffic to it, such as a Network Function (NF) producer to reduce such traffic. Overload control may be performed as covered, for example, in clause 6.4 of 3GPP TS 29.500 v17.1.0 5G System; Technical Realization of Service Based Architecture; Stage 3.

The cited TS indicates that a server may request the clients to reduce their traffic in a percentage, towards the indicated scope, that is, an NF service instance, NF service Set, NF instance or NF Set, or additionally Data Network Name (DNN) and/or Network Slice Selection Assistance Information (NSSAI) when the server is the Session Management Function (SMF).

The Overload control may be based on information provided by the NF producer directly, including a Hypertext Transfer Protocol (HTTP) header, such as an Overload Control Information (OCI) header.

While the possibility to control overload may help to improve the performance of a network, the existing methods to control overload, such as the Overload Control just described, may result in end-to-end services being unnecessarily negatively unaffected.

### SUMMARY

As part of the development of embodiments herein, the problem with existing methods will be first more particularly identified and discussed.

According to existing methods, in an overload situation, a server indicates the same traffic reduction towards all its clients, since 3GPP does not provide any means to distinguish whether a client is more active and possibly suffering a traffic peak, and then only that client may the responsible for the overload situation the server is entering.

FIG. 1 is a signalling diagram illustrating an existing method to manage traffic overload. A set, Set 1, of servers comprises a first server 11, Server1, 11 and a second server 12, Server2, 12. Each of Server 1 and Server 2 provide a service, Service A, to any of a first client, Client1, 13 and a second client, Client2, 14. In step 1, Client1 13 sends a service A request to Server1 11a as a Nnfp_serviceA operation request (req) message. At step 2, Server1 11 sends a response to the service request as a Nnfp_serviceA operation response (rsp) message. Steps 1 and 2 are repeated many times, as Client1 13 is suffering a traffic peak. In step 3, Server1 11 is entering overload due to the potentially massive number of requests received from Client 1 13. This activates overload control in Server1 11, that will start including the OCI header in subsequent responses, indicating a traffic reduction. Since Server1 11 has entered overload, it will include a requested traffic reduction in all the responses, towards all the clients. In step 4, Client 1 13 sends a further service A request to Server1 11 as a further Nnfp_serviceA operation req message. In step 5, Server1 11 sends a response to the Client 1 13 as a further Nnfp_serviceA operation rsp message, wherein traffic reduction is requested towards Client1 13. The response includes an OCI header which indicates that a reduction by 40% of traffic is requested. In step 6, Client 1 13 will then need to start abating traffic at the indicated percentage. After step 6, even though Client1 13 has started abating traffic, still the Server1 11 may remain overloaded. This may last long, depending on the amount of traffic received. Requesting a reduction towards clients do not even ensure the traffic peak will be overcome in certain conditions. In step 7, Client2 14, which has experienced normal traffic all along, sends its own service A request to Server1 11 with a Nnfp_serviceA operation req message. In step 8, Server1 11 requests Client2 14 as well to reduce traffic with a Nnfp_serviceA operation rsp message including an OCI header which indicates that a reduction by 40% of traffic is requested. In step 9, Client2 14 also abates traffic by 40%. This is performed, even though this Client may be processing at a low rate. This may cause that requests are throttled, and then end-to-end procedure would fail. Apart from that, the contribution from this traffic abatement to the resolution of the overload situation in NFp1 would be irrelevant since it is mainly caused by Client1 13. FIG. 1 therefore illustrates how a traffic peak at Client1 13 affects Client2 14.

As may be understood from the example illustrated in FIG. 1, requesting the same reduction of traffic towards all the clients according to existing methods will penalize the clients that may be processing traffic normally, e.g., a second client, that even when acting correctly, or when sending a very slow rate of requests towards the server, will be equally requested to reduce its traffic towards the scope indicated by the server. This may cause that all the clients need to abate traffic, even when they may not be responsible for the overload situation, which may be understood to affect end-to-end services. Moreover, reducing the traffic of such clients may be understood to have a low impact in reducing the overload, which therefore means at their traffic is abated unnecessarily.

It is an object of embodiments herein to improve the handling of traffic in a communications network. More particularly, it is an object of embodiments herein to improve the handling of traffic from a node causing overload in a communications network.

According to a first aspect of embodiments herein, the object is achieved by a computer-implemented method, performed by a first node. The method is for handling traffic from a second node. The first node and the second node operate in the communications network. The first node sends a message to the second node. The message comprises a request to abate traffic from the second node to the first node. The message further comprises an indication identifying the second node. In an embodiment, the indication may further identify a group of nodes of a same type to which the second node belongs.

According to a second aspect of embodiments herein, the object is achieved by a computer-implemented method, performed by the second node. The method is for handling traffic from the second node. The second node operates in the communications network. The second node receives the message from the first node operating in the communications network. The message comprises the request to abate traffic from the second node to the first node. The message further comprises an indication identifying the second node. In an embodiment, the indication may further identify a group of nodes of a same type to which the second node belongs.

In cases wherein no traffic is to be abated, the message may indicate that zero traffic is to be abated.

In cases wherein traffic is to be abated from any one of the second node and one or more other second nodes operating in the communications network, the message may indicate respective traffic to be abated, for example as a percentage of traffic.

According to a third aspect of embodiments herein, the object is achieved by the first node, for handling the traffic from the second node. The first node and the second node are configured to operate in the communications network. The first node is further configured to send the message to the second node. The message is configured to comprise the request to abate traffic from the second node to the first node. The message is further configured to comprise the indication configured to identify the second node. In an embodiment, the indication may further be configured to identify the group of nodes of the same type to which the second node is configured to belong.

According to a fourth aspect of embodiments herein, the object is achieved by the second node, for handling the traffic from the second node. The second node is configured to operate in the communications network. The second node is further configured to receive the message from the first node configured to operate in the communications network. The message is configured to comprise the request to abate traffic from the second node to the first node. The message is further configured to comprise an indication configured to identify the second node. In an embodiment, the indication may further be configured to identify a group of nodes of a same type to which the second node belongs.

In cases wherein no traffic is to be abated, the message may be configured to indicate that zero traffic is to be abated.

In cases wherein traffic is to be abated from any one of the second node and one or more other second nodes operating in the communications network, the message may be configured to indicate respective traffic to be abated, for example as a percentage of traffic.

By sending the message to the second node comprising the request to abate traffic with the indication, the first node may be enabled to avoid requesting that all the nodes sending traffic to the first node abate traffic. By sending the message with the indication identifying the second node, the first node may be enabled to request that only the nodes that may be causing an overload at the first node abate their traffic, as identified by the indication. Hence, reduction of traffic is optimized, since traffic from the nodes that may not be overloading traffic may be enabled to continue normally, without penalties of any type, such as lost of requests, sessions, delays, etc. Similarly, in the first node, overload may be enabled to be abated, but without causing any disturbances when not required, such as for processing of traffic from nodes that may not be causing overload.

By sending the message with the indication further identifying the group of nodes of a same type to which the second node belongs, the first node may be enabled to at least reduce the number of nodes which may be asked to abate their traffic, since nodes not being of the same type as the second node may be enabled to refrain from abating traffic. Hence, the method performed by the first node may enable to manage an overload situation while avoiding to unnecessarily affect end-to-end services in a negative manner. Consequently, the performance of the communications network is enabled to be improved.

Similarly, by the second node receiving the message comprising the request to abate traffic and the indication, the second node may be enabled to determine if it is to abate traffic or not. If the indication identifies the second node or, further, the group of nodes of the same type to which the second node is configured to belong, and the message comprises the request to abate traffic, the second node may be enabled to determine it has to abate traffic. If the message further comprises the indication configured to identify the second node or, further, the group of nodes of the same type to which the second node is configured to belong; but the message indicates that zero traffic is to be abated, the second node may be enabled to determine it does not need to abate traffic. If the message further comprises the respective indication identifying any of the one or more other second nodes that are to abate traffic, or, further, the respective group of nodes of the same type to which the one or more other nodes are configured to belong and the message indicates that traffic is to be abated, the second node may be enabled to determine it does not need to abate traffic. Hence, the method performed by the second node may enable the second node to avoid unnecessarily abating traffic while enabling the first node to manage traffic overload, or to manage traffic overload, if necessary, by abating traffic only when it may be helpful. Consequently, the performance of the communications network is enabled to be improved.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of traffic management, according to existing methods.

FIG. 2 is a schematic diagram illustrating a non-limiting example of a communications network, according to embodiments herein.

FIG. 3 is a flowchart depicting embodiments of a method in a first node, according to embodiments herein.

FIG. 4 is a flowchart depicting embodiments of a method in a second node, according to embodiments herein.

FIG. 5 is a schematic diagram depicting a non-limiting example of signalling between nodes in a communications system, according to embodiments herein.

FIG. 6 is a schematic diagram depicting another non-limiting example of signalling between nodes in a communications system, according to embodiments herein.

FIG. 7 is a schematic diagram depicting yet another non-limiting example, a) and b), of signalling between nodes in a communications system, according to embodiments herein.

FIG. 8 is a schematic block diagram illustrating two non-limiting examples, a) and b), of a first node, according to embodiments herein.

FIG. 9 is a schematic block diagram illustrating two non-limiting examples, a) and b), of a second node, according to embodiments herein.

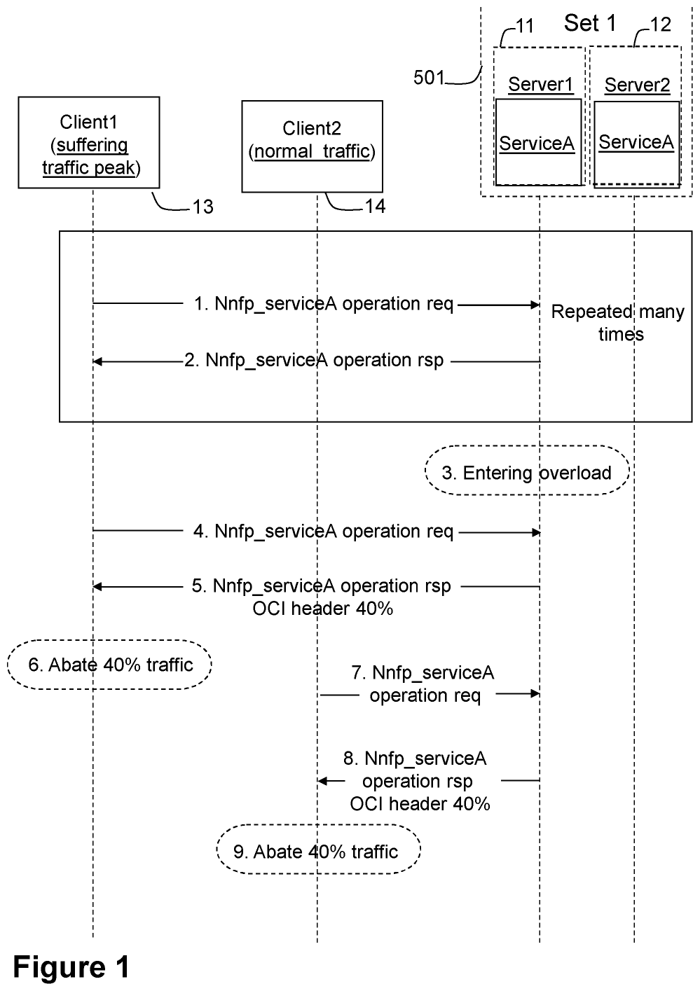

### DETAILED DESCRIPTION

Embodiments herein may be understood to relate to methods to address the problems explained in the Summary section, and which may be understood to relate to traffic reduction by an offending node.

As a summarized overview, embodiments herein may be understood to relate to an enhancement for the Overload Control mechanism based on the inclusion of the OCI header. This may involve two different tasks: the identification by a server of the offending client(s), and the application of traffic reduction just by the offending client(s). The server may keep including the OCI header in the responses to the requests from all the clients, but it may as well include as new additional information the identification of the offending client(s). According to embodiments herein, this additional information may be the same used to identify the client, e.g., a User-Agent or NF instance identification, e.g., an NF service instance identification. Then the client may need to identify if it is the right receiver for this information. That is, only client(s) with the same User-Agent may understand that they are to apply the reduction, or just the client with the same NF instance identification, e.g., the same NF service instance identification.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

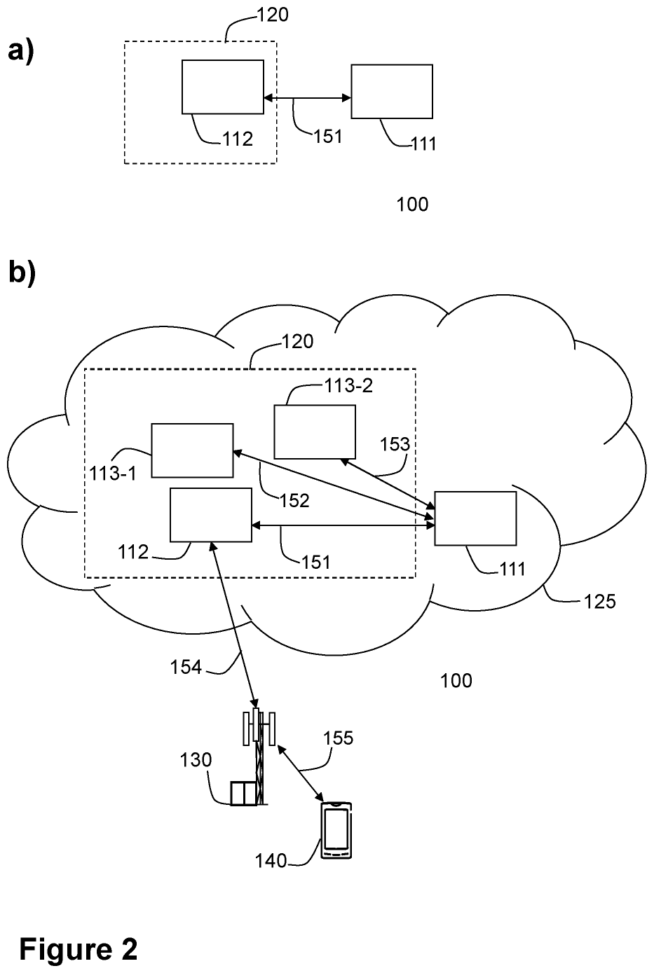

FIG. 2 depicts two non-limiting examples, in panels “a” and “b”, respectively, of a communications network 100, in which embodiments herein may be implemented. In some example implementations, such as that depicted in the non-limiting example of FIG. 2a, the communications network 100 may be a computer network. In other example implementations, such as that depicted in the non-limiting example of FIG. 2b, the communications network 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, or a newer system supporting similar functionality. The telecommunications system may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band loT (NB-IoT).

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

The communications system 100 may comprise a plurality of nodes, whereof a first node 111 and a second node 112 are depicted in FIG. 2. It may be understood that the communications network 100 may comprise more nodes than those represented on panel a) of FIG. 2. In some examples, such as that depicted on panel b) of FIG. 2, the communications network 100 may comprise one or more other second nodes 113. In the non-limiting example of panel b) of FIG. 2, and for illustration purposes only, the one or more other second nodes 113 may comprise a first other second node 113-1 and a second other second node 113-2. In other examples not depicted in FIG. 2, the communications network 100 may comprise other second nodes. The second node 112 may belong to a group of nodes of a same type 120. The one or more other second nodes 113 may belong to a respective group of nodes of a same type. In the non-limiting example of FIG. 2, the respective group of nodes of the same type to which the one or more other second nodes 113 belong is the same group as the group of nodes of the same type 120 to which the second node 112 belongs.

Any of the first node 111, the second node 112 and the one or more other second nodes 113 may be understood, respectively, as a first computer system and a second computer system. In some examples, any of the first node 111, the second node 112 and the one or more other second nodes 113 may be implemented as a standalone server in e.g., a host computer in the cloud 125, as depicted in the non-limiting example depicted in panel b) of FIG. 2. Any of the first node 111, the second node 112 and the one or more other second nodes 113 may in some examples be a distributed node or distributed server, with some of their respective functions being implemented locally, e.g., by a client manager, and some of its functions implemented in the cloud 125, by e.g., a server manager. Yet in other examples, the first node 111, the second node 112 and the one or more other second nodes 113 may also be implemented as processing resources in a server farm.

In embodiments herein, the first node 111 may be a server having a capability to serve the second node 112, the group of nodes of the same type to which the second node 112 belongs, or the one or more other second nodes 113. In particular examples, the first node 111 may be a Session Management Function (SMF). The second node 112, each of the group of nodes of the same type or any of the one or more other second nodes 113, may be a client. In the present disclosure, the term client may be used generically as the sender of a request, it may refer to an NF consumer or Service Communication Proxy (SCP), for regular requests, or NF producer, for notification requests.

The communications network 100 may comprise one or more radio network nodes, whereof a radio network node 130 is depicted in FIG. 2b. The radio network node 130 may typically be a base station or Transmission Point (TP), or any other network unit capable to serve a wireless device or a machine type node in the communications network 100. The radio network node 140 may be e.g., a 5G gNB, a 4G eNB, or a radio network node in an alternative 5G radio access technology, e.g., fixed or WiFi. The radio network node 130 may be e.g., a Wide Area Base Station, Medium Range Base Station, Local Area Base Station and Home Base Station, based on transmission power and thereby also coverage size. The radio network node 130 may be a stationary relay node or a mobile relay node. The radio network node 130 may support one or several communication technologies, and its name may depend on the technology and terminology used. The radio network node 130 may be directly connected to one or more networks and/or one or more core networks.

The communications network 100 covers a geographical area which may be divided into cell areas, wherein each cell area may be served by a radio network node, although, one radio network node may serve one or several cells.

The communications network 100 may comprise a device 140. The device 140 may be also known as e.g., user equipment (UE), a wireless device, mobile terminal, wireless terminal and/or mobile station, mobile telephone, cellular telephone, or laptop with wireless capability, or a Customer Premises Equipment (CPE), just to mention some further examples. The device in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100. In some particular embodiments, the device may be an IoT device, e.g., a NB IoT device.

The first node 111 may communicate with the second node 112 over a first link 151, e.g., a radio link or a wired link. The first node 111 may communicate with the second second node 112-2 over a second link 152, e.g., a radio link or a wired link. The first node 111 may communicate with the third second node 112-3 over a third link 153, e.g., a radio link or a wired link. The second node 112 may communicate, directly or indirectly with the radio network node 140 over a fourth link 154, e.g., a radio link or a wired link. The radio network node 140 may communicate with the device 140, over a fifth link 155, e.g., a radio link. Any of the first link 151, the second link 152 and the respective third link 153 may be a direct link or it may go via one or more computer systems or one or more core networks in the communications network 100, or it may go via an optional intermediate network. The intermediate network may be one of, or a combination of more than one of, a public, private or hosted network; the intermediate network, if any, may be a backbone network or the Internet, which is not shown in FIG. 2.

In general, the usage of “first”, “second”, “third”, “fourth” and/or “fifth” herein may be understood to be an arbitrary way to denote different elements or entities, and may be understood to not confer a cumulative or chronological character to the nouns these adjectives modify.

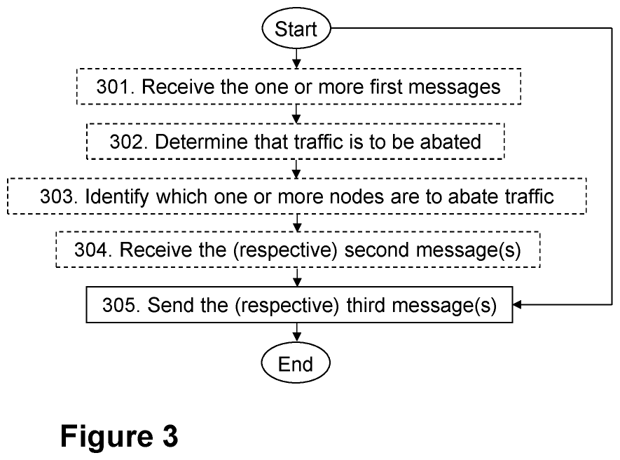

Embodiments of a computer-implemented method, performed by the first node 111, will now be described with reference to the flowchart depicted in FIG. 3. The method may be understood to be for handling traffic from the second node 112. The first node 111 and the second node 112 operate in the communications network 100.

In some embodiments wherein the communications network 100 may be a 5G network, the first node 111 may be a server and the second node 112 may be client of the server. In some examples, the client may be an NF consumer or an NF producer, and as well the server may be an NF consumer or an NF producer.

The method may comprise the actions described below. In some embodiments all the actions may be performed. In some embodiments one or more of the actions may be performed. In FIG. 3, optional actions are represented with dashed boxes. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

### Action 301

During the course of operations of the communications network 100, the second node 112, as well as any of the other second nodes 113 operating in the communications network 100, may send requests to the first node 111, by each sending one or more first messages, e.g., one or more requests, to which the first node 111 may be to send a respective response.

In this Action 301, the first node 111 may receive one or more first messages from the second node 112, or from the group of nodes of the same type 120 to which the second node 112 belongs. The group of nodes of the same type 120 may refer for example to NFs of a same type, e.g., Unified Data Management (UDM), e.g., in some examples, the one or more other second nodes 113. Each of the one or more first messages may comprise a first indication identifying the sender node, e.g., uniquely identifying the sender node.

In some embodiments, the second node 112 may be one of a plurality of second nodes, such as the group of nodes of the same type 120 operating in the communications network 100. In some of such embodiments, the receiving in this Action 301 of the one or more first messages may comprise receiving respective one or more first messages from each of the second nodes in the plurality of second nodes. At least one, of the respective one or more first messages may comprise a respective first indication identifying, e.g., uniquely identifying, a respective second node of the plurality of second nodes, that is, the respective sender. This may be the case for example, if some of the second nodes may not support the new feature described herein, and may not include the respective indication in their respective one or more first messages. In typical cases, each of the respective one or more first messages may comprise the respective first indication identifying, e.g., uniquely identifying, the respective second node of the plurality of second nodes, that is, the respective sender. The respective first indication may further identify, e.g., uniquely, a respective group of nodes of a same type to which the respective second node of the plurality of second nodes 120 belongs.

Each of the one or more first messages may be a request.

The receiving of the one or more first messages may be performed e.g., via the first link 151.

The first indication may be, according to a first possibility, a first identifier of a network function instance corresponding to the second node 112, e.g. a NF instance identifier or NF service instance identifier. In such examples, the first indication may be understood to identify the server node. According to some embodiments herein, the NF service instance identification may be included in all requests, possibly as a new HTTP header.

The first indication may be, according to a second possibility, a second identifier of a network function type of the second node 112, e.g., a User-Agent header. In such examples, the first indication may be understood to further identify the group of nodes of the same type to which the second node belongs.

In some embodiments, the first indication may be comprised in a Hypertext Transfer Protocol (HTTP) header. According to TS 29.500 v17.1.0 5G, User Agent may be a mandatory element to support HTTP header, see Section 5.2.2.2:

TABLE 5.2.2.2-1
Mandatory to support HTTP request standard headers.

| Name | Reference | Description |
|---|---|---|
| . . . | | |
| User-Agent | IETF RFC | This header is to be mainly used to identify the |
| | 7231 [11] | NF type of the HTTP/2 client. |
| | | The pattern of the content may be required to |
| | | start with the value of NF type, e.g., udm, see |
| | | NOTE 1, and followed by a “—” and any other |
| | | specific information if needed afterwards. |
| . . . | | |

This HTTP header is today standardized to be included in all the requests. It has the constraint that it identifies just the NF type, not specific instances.

By receiving the first indication, or the respective first indication, in the one of more first messages in this Action 301, the first node 111 may be enabled to then identify which nodes may be sending too many messages, and hence, which nodes are to abate traffic, whenever the first node 111 may determine that traffic is to be abated. The first node 111 may thereby be enabled to instruct the nodes that may be causing the traffic overload, that is, the offending clients, to abate traffic, and not other nodes which may not be causing traffic overload. This therefore provides a mechanism to allow that the traffic reduction may be only applied on the offending client(s). Hence, the first node 111 may be enabled to manage traffic more efficiently, by handling traffic overload with the offending clients, and refraining from disturbing clients that may be sending normal amounts of traffic.

### Action 302

In some embodiments, the first node 111, in this Action 302, may determine, after having received the one or more first messages, that traffic is to be abated. In other words, the first node 111 may identify that it is entering overload.

Determining may be understood as e.g., calculating, deciding or detecting.

The determining in this Action 302 may be performed according to known methods.

In embodiments wherein the second node 112 may be one of the plurality of second nodes, such as the group of nodes of the same type 120, the determining in this Action 302 that traffic is to be abated may be performed after having received at least some of the respective one or more first messages.

The first node 111 may determine whether or not traffic needs to be abate immediately for each request, or it determine that every now and then, e.g., even after a few one or more first messages and/or after a certain period of time.

By determining that traffic is to be abated in this Action 302, the first node 111 may be enabled to take action in order to manage the traffic overload, so that the performance of the communications network may not be negatively affected.

### Action 303

In this Action 303, the first node 111 may identify, based on the first indication comprised in the received one or more first messages, that the second node 112 is to abate traffic. That is, the first node 111 may identify that the second node 112 is an offending client by the information provided in the request.

In embodiments wherein the second node 112 may be one of the plurality of second nodes, such as the group of nodes of the same type 120, the identifying in this Action 303 may comprise identifying which one or more nodes, out of the plurality of second nodes 120, are to abate traffic, based on the received respective first indications. This may be understood to mean that one or more of the plurality of second nodes may be identified in this Action 303 as the origin of the traffic that may need to be abated.

Two possibilities may be considered. According to a first possibility, the identification in this Action may be based on the second identifier of a network function type of the second node 112, e.g., the User-Agent header, included in the request.

According to a first possibility, the identification in this Action may be based on the inclusion of the first identifier of the network function instance corresponding to the second node 112, e.g. the NF service instance identification in all the requests.

This Action 303 may be understood to be performed only after the first node 111 may have determined that traffic is to be abated in Action 302.

The first node 111, in this Action 303, may evaluate the implication of the respective one or more first messages received from each second node in the internal load increase of the internal resources. Then, the first node 111 may evaluate that traffic from, e.g., the second node 112, may need to be abated, because the increase of resource usage may eventually cause overload if not decreased. Then, it may be this internal evaluation of the responsibility of the second node 112 in the increase of resource usage at the first node 111 what may trigger the overload control mechanism in the first node 111, towards each second node.

By identifying, in this Action 304, that the second node 112 is to abate traffic, or which one of or more nodes are to abate traffic, based on the first indication, or the respective first indication, comprised in the received one or more first messages, the first node 111 may be enabled to send an instruction to abate traffic to the nodes that may be causing the traffic overload, that is, to the offending clients, and not to other nodes which may not be causing traffic overload. The first indication, or the respective first indication, may enable the first node 111 to understand the contribution of each second node to the total measured internal load/overload. This may therefore be understood to provide a mechanism to allow that the traffic reduction may be only applied on the offending client(s) and not to clients with normal traffic. Hence, the first node 111 may be enabled to manage traffic more efficiently, by handling traffic overload with the offending clients, and refraining from disturbing clients that may be sending normal traffic. Consequently, the performance of the communications network is enabled to be improved.

### Action 304

In some embodiments, in this Action 304, the first node 111 may receive, after having identified that the second node 112 is to abate traffic, a second message from the second node 112. The second message, e.g., a further request, may comprise the first indication identifying the second node 112. In some examples, the second message may comprise the first indication uniquely identifying the second node 112 or, further, the group of nodes of the same type to which the second node 112 belongs.

The second message may be understood as a new request from the second node 112. This second message may be understood to not be a special message, in the sense that it may be understood to also contribute to the overload. The second message may be understood as one more message from the second node 112, that may contribute to the processing that may be required in the first node 111, but also, this may be used to identify the second node 112. This identification may be understood to be also required for all the first messages, because it is not one message what may determine the reduction of traffic, but the processing on the first node 111 to identify that the traffic pattern, or amount of traffic from a certain second node, e.g., client X, may be causing an increase in some or all the internal resources, even just one resource, and may compromise the normal working and/or execution on the first node 111.

The receiving of the second message may be performed e.g., via the first link 151.

In embodiments wherein the second node 112 may be one of the plurality of second nodes, such as the group of nodes of the same type 120, the first node 111 may additionally receive a respective second message from any of the other nodes in the plurality of second nodes.

### Action 305

In this Action 305, the first node 111, sends a message to the second node 112. The message from the first node 111 may be understood to be a third message. The message, that is, the third message, comprises a request to abate traffic from the second node 112 to the first node 111. The message further comprises an indication identifying the second node 112, e.g. uniquely identifying the second node 112.

In some embodiments, the indication in the message may further identify the group of nodes of a same type 120 to which the second node 112 belongs, e.g., the indication may further identify the NF type of the second node 112.

The message sent to the second node 112 may be understood as a third message and may be understood to be based on the received second message. That is, the third message sent in this Action 305 may be understood to be a response to the second message received in Action 304. This may be understood to mean that, after the second node 112 may have been identified in Action 303 as being a node that is to abate traffic, e.g., for being a node sending a high number of first messages, the sending of the second indication to the second node 112 in this Action 305 may only be performed with the proviso that the second node 112 sends, subsequently, a further message, e.g., a further request, to the first node 111, and not otherwise.

In some embodiments, the indication sent in the message to the second node 112 may be a second indication based on the received first indication in Action 301. That is, the indication may be understood to correspond to, or be the same as, the first indication, although sent in the opposite direction, that is, from the first node 111 to the second node 112.

Accordingly, the sent indication may be the second indication, and may be one of the following. According to a first possibility, the second indication may be the first identifier of the network function instance corresponding to the second node 112, e.g. the NF service instance identifier.

According to a second possibility, the second indication may be the second identifier of the network function type of the second node 112, e.g., the User-Agent header.

The sending of the message may be performed e.g., via the first link 151.

The second indication may be based on a result of the identifying 303. This may be understood to mean that the sending of the second indication to the second node 112 in this Action 305 may only be performed with the proviso that the second node 112 may have been identified in Action 303 as being a node that is to abate traffic, e.g., for being a node sending a high number of first messages.

The sent message to the second node 112 in this Action 305 may comprise at least one of: a further indication of an amount of traffic to be abated, and Overload Control Information (OCI). The amount of traffic to be abated may be indicated, e.g., as a percentage. This may enable the first node 111 to indicate that the amount of traffic reduction included may be specific for the second node 112. The indication may be comprised in an HTTP header, for example, the OCI may be included in the existing HTTP OCI header described in Action 301. But as well it may be conveyed in another HTTP header, that may be sent as a companion of the OCI header.

The first node 111 may determine the need to reduce traffic in Action 302, and then in the subsequent response, after the determination may have been performed, it may include the OCI. This may be the immediate response to any of the received one or more first messages, or a response to any subsequent requests, such as a response to the received second message in Action 304.

In embodiments wherein the second node 112 may be one of the plurality of second nodes, such as the group of nodes of the same type 120, and wherein only the second node 112 may have been identified, out of the plurality of second nodes, as having to abate traffic, the sending in this Action 305 of the third message may comprise sending a respective third message to each of the second nodes in the plurality of second nodes from which a respective second message or a respective first message may have been received after the second node 112 may have been identified. Each of the sent respective third messages may comprise a respective indication identifying, e.g., uniquely identifying, the second node 112 as having to abate traffic, or further, the respective group of nodes of a same type 120 to which the second node 112 belongs.

In some embodiments, wherein two or more nodes, out of the plurality of second nodes may have been identified in Action 304 as having to abate traffic, the sending in this Action 305 of the third message may comprise sending a respective third message to each of the second nodes in the plurality of second nodes from which the respective second message or a respective first message may have been received after the two or more nodes may have been identified by the first node 111 as having to abate traffic. Each of the sent respective third messages may comprise one of the following. For the second nodes from which the respective second message or the respective first message may have been received and which second nodes may have to abate traffic, the sent respective third messages to them may comprise a respective indication identifying, e.g., uniquely identifying, the respective node having sent the respective second message or the respective first message that is to abate traffic, or, further, a respective group of nodes of a same type to which the identified respective node belongs. For the second nodes from which the respective second message or the respective first message may have been received and which second nodes may not have to abate traffic, one of the following options may apply. According to a first option i), the sent respective third messages may lack the respective indication and may indicate that traffic is to be abated. Since the node receiving this respective third message may then not find its identifier, it may interpret that the indication to abate traffic is not directed to it, and ignore it. According to a second option ii), the sent respective third messages may comprise the respective indication identifying, e.g., uniquely identifying, the respective node of the plurality of nodes 120 that have not been identified as having to abate traffic, or, further, a respective group of nodes of a same type to which the respective node belongs, and the sent respective third messages may indicate that zero traffic is to be abated. Hence, although in this case the node receiving this respective third message may find its identifier, it may refrain from abating traffic, since it is instructed to abate zero traffic.

According to a third option, the sent respective third messages may comprise the respective indication identifying, e.g., uniquely identifying, any of the two or more nodes that are to abate traffic, or further, a respective group of nodes of a same type to which the indicated identified node belongs, and the sent respective third messages may indicate that traffic is to be abated. According to this third option, the node receiving this respective third message may understand the instruction to abate traffic is directed to another node, and it may then ignore it and refrain from abating traffic.

In some embodiments, the sent respective third messages may comprise a respective further indication of a respective amount of traffic to be abated. At least two of the respective amounts may be different. That is, the amount of traffic to be abated indicated by the respective further indication may be different towards each second node. This may be understood to beneficially enable to adjust the amount of traffic that a node may have to abate to the amount of traffic overload it may be responsible for. That is, this may enable the first node 111 to indicate that the amount of traffic reduction included may be specific for each second node. For example, while a node may have to abate 40% of traffic, another node may have to abate 10% of traffic, or even 0% of traffic, if for example, such node has normal traffic, and the first node 111 may continue to handle it in spite of the overload generated by traffic coming in from other nodes in the plurality.

By sending the message to the second node 112 comprising the request to abate traffic and the indication, the first node 111 may be enabled to avoid requesting that all the nodes sending traffic to the first node abate traffic. By sending the message with the indication identifying, e.g., uniquely identifying, the second node 112, the first node may be enabled to request that only the nodes that may be causing the overload at the first node 111 abate their traffic, as identified by the indication.

By sending the message with the indication further identifying, e.g., uniquely identifying, the group of nodes of a same type to which the second node 112 belongs, the first node 111 may be enabled to at least reduce the number of nodes which may be asked to abate their traffic, since nodes not being of the same type as the second node 112 may be enabled to refrain from abating traffic. Hence, the method performed by the first node 111 may enable the first node 111 to manage an overload situation while avoiding to unnecessarily affect end- to-end services in a negative manner. Traffic from the nodes that may not be overloading traffic may be enabled to continue normally, without penalties of any type, such as loss of requests, sessions, delays, etc. Similarly, in the first node, overload may be enabled to be abated, but without causing any disturbances when not required, such as for processing of traffic from nodes that may not be causing overload. Consequently, the performance of the communications network is enabled to be improved.

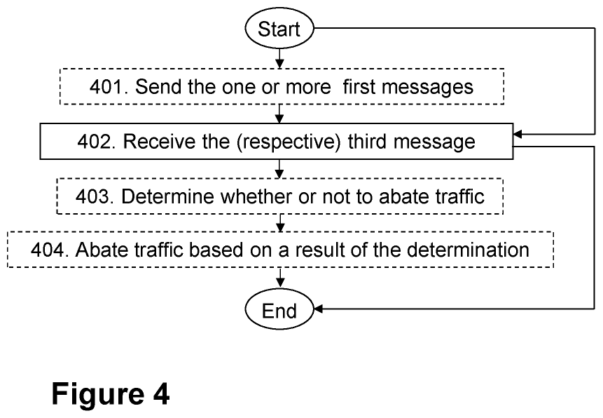

Embodiments of a computer-implemented method performed by the second node 112, will now be described with reference to the flowchart depicted in FIG. 4. The method may be understood to be for handling traffic from the second node 112. The second node 112 operates in the communications network 100.

The method may comprise the following actions. Several embodiments are comprised herein. In some embodiments, the method may comprise all actions. In other embodiments, the method may comprise one or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are depicted with dashed lines.

The detailed description of some of the following corresponds to the same references provided above, in relation to the actions described for the first node 111 and will thus not be repeated here to simplify the description. For example, in some embodiments wherein the communications network 100 may be a 5G network, the first node 111 may be a server and the second node 112 may be client of the server.

### Action 401

In this Action 401, the second node 112 may send one or more first messages to the first node 111. Each of the one or more first messages may comprise the first indication identifying the second node 112, e.g., uniquely identifying the second node 112. In some examples, the first indication may further identify the group of nodes of the same type 120 to which the second node 112 belongs.

Each of the one or more first messages may be a request.

It may be understood that from the perspective of the second node 112, unknowingly to the second node 112, one of the one or more first messages may correspond to the second message described earlier. That is, the message sent by the second node 112 after the first node 111 may have determined that traffic is to be abated.

The first indication may be, according to a first possibility, the first identifier of the network function instance corresponding to the second node 112, e.g., the NF service instance identifier. According to some embodiments herein, the NF service instance identifier may be included in all requests, possibly as a new HTTP header.

The first indication may be, according to a second possibility, the second identifier of the network function type of the second node 112, e.g., a User-Agent header.

In some embodiments, the first indication may be comprised in the HTTP header.

The sending of the one or more first messages may be performed e.g., via the first link 151.

As explained earlier, in some embodiments, the second node 112 may be one of the plurality of second nodes, such as the group of nodes of the same type 120 operating in the communications network 100. In some of such embodiments, the sent one or more first messages in this Action 401 may be among the respective one or more first messages sent by each of the second nodes in the plurality of second nodes. At least one of the respective one or more first messages may comprise the respective first indication identifying, e.g., uniquely identifying, the respective second node of the plurality of second nodes, that is, the respective sender. The second node 112 may have been identified as one of the one or more nodes, out of the plurality of second nodes 120 which may have to abate traffic, based on the respective first indications. In some examples, at least one of the respective one or more first messages may comprise the respective first indication further identifying the respective group of nodes of the same type to which the respective second node of the plurality of second nodes 120 belongs.

In embodiments wherein the second node 112 may be one of the plurality of second nodes, such as the group of nodes of the same type 120, each of the respective one or more first messages may comprise the respective first indication identifying, e.g., uniquely identifying, the respective second node of the plurality of second nodes 120.

### Action 402

In this Action 402, the second node 112 receives the message from the first node 111 operating in the communications network 100. The message comprises the request to abate traffic from the second node 112 to the first node 111 and the indication identifying the second node 112, e.g., uniquely identifying the second node 112.

In some embodiments, the indication in the message may further identify the group of nodes of the same type 120 to which the second node 112 belongs.

The message from the first node 111 may be understood to be a third message.

The message may further comprise one of the following, based on whether or not the second node 112 is to abate traffic or not.

In some embodiments, if no traffic is to be abated, the message may indicate that zero traffic is to be abated.

In some embodiments, if traffic is to be abated from any one of the second node 112 and the one or more other second nodes 113 operating in the communications network 100, the message may indicate respective traffic to be abated.

In some examples, with the proviso that the second node 112 is to abate traffic, the message may further comprise the indication identifying, e.g., uniquely identifying, the second node 112. The message may further indicate the group of nodes of the same type 120 to which the second node 112 belongs.

With the proviso that the second node 112 is not to abate traffic, and that one or more other second nodes 113 operating in a communications network 100 are to abate traffic, the message may further comprise one of the following. According to a first option, the message may further comprise the indication identifying, e.g., uniquely identifying, the second node 112 or, further, the group of nodes of the same type 120 to which the second node 112 belongs. In such embodiments, the message may indicate that zero traffic is to be abated.

According to a second option, the message may further comprise the respective indication identifying, e.g., uniquely identifying, any of the one or more other second nodes 113 that are to abate traffic. The respective indication may further identify the respective group of nodes of a same type 120 to which the one or more other nodes 113 belong. In such embodiments, the message may indicate that traffic is to be abated.

In some embodiments, the indication received in the message from the first node 111 may be the second indication based on the sent first indication in Action 401. That is, the indication may be understood to correspond to, or be the same as, the first indication, although sent in the opposite direction, that is, from the first node 111 to the second node 112.

Accordingly, the received indication may be the second indication, and may be one of the following. According to the first possibility, the second indication may be the first identifier of the network function instance corresponding to the second node 112, e.g., the NF service instance identifier.

The second indication may be, according to the second possibility, the second identifier of the network function type of the second node 112, e.g., the User-Agent header.

The receiving of the message may be performed e.g., via the first link 151.

In some embodiments, the indication may be comprised in the HTTP header. The message received from the first node 111 in this Action 402 may comprise at least one of: the OCI, and the further indication of the amount of traffic to be abated.

In embodiments wherein the second node 112 may be one of the plurality of second nodes, such as the group of nodes of the same type 120, and wherein only the second node 112 may have been identified, out of the plurality of second nodes, as having to abate traffic, the received message may be one of respective messages to each of the second nodes in the plurality of second nodes. Each of the respective messages may comprise the respective indication identifying, e.g., uniquely identifying, the second node 112 as having to abate traffic, or further, the respective group of nodes of the same type to which the second node 112 belongs.

In some embodiments, wherein two or more nodes, out of the plurality of second nodes may have been identified in Action 304 as having to abate traffic, the received message may be one of respective messages to each of the second nodes in the plurality of second nodes identified by the first node 111 as having to abate traffic. Each of the respective messages may comprise one of the following. For the second nodes from which the respective message may have been received and which second nodes may have to abate traffic, the respective indication identifying, e.g., uniquely identifying, the respective node that is to abate traffic, or further, the respective group of nodes of the same type 120 to which the identified respective node belongs. For the second nodes which may not have to abate traffic, one of the following options may apply. According to a first option i), the respective messages may comprise the respective indication identifying, e.g., uniquely identifying, the respective node of the plurality of nodes 120 that have not been identified as having to abate traffic, or further, the respective group of nodes of the same type 120 to which the respective node belongs. In such embodiments, the respective messages may indicate that zero traffic is to be abated. According to a second option ii), the respective messages may comprise the respective indication identifying, e.g., uniquely identifying, any of the two or more nodes that are to abate traffic, or further, the respective group of nodes of the same type 120 to which the respective node belongs. In such embodiments, the respective messages may indicate that traffic is to be abated.

In some embodiments, the respective messages may comprise the respective further indication of the respective amount of traffic to be abated. At least two of the respective amounts may be different.

The respective messages may comprise OCI.

### Action 403

In this Action 403, the second node 112 may determine, based on the indication comprised in the received message, whether or not traffic is to be abated.

Determining may be understood as e.g., calculating, deciding or detecting.

In order to perform the determining in this Action 403, the second node 112 may interpret the content of the received message, and inspect both of the request to abate traffic, and the indication.

With the proviso that the indication identifies, e.g., uniquely identifies, the second node 112 or further, the group of nodes of the same type 120 to which the second node 112 belongs, and the further indication of the amount of traffic to be abated indicates that an amount of traffic exceeding zero % is to be abated, the second node 112 may determine that it is to abate traffic.

With the proviso that the indication identifies, e.g., uniquely identifies, the second node 112 or further, the group of nodes of the same type 120 to which the second node 112 belongs, and wherein the message, that is, the further indication, indicates that zero traffic is to be abated, the second node 112 may determine that it is not to abate traffic, and that one or more other second nodes 113 operating in a communications network 100 are to abate traffic.

With the proviso that the respective indication identifies, e.g., uniquely identifies, any of the one or more other second nodes 113 that are to abate traffic, or further, the respective group of nodes of the same type 120 to which the one or more other nodes 113 belong, and the message indicates that traffic is to be abated, the second node 112 may determine that it is not to abate traffic, and that one or more other second nodes 113 operating in a communications network 100 are to abate traffic.

### Action 404

In this Action 404, the second node 112 may abate traffic to the first node 111, based on a result of the determination performed in Action 403.

The methods just described as being implemented by the first node 111 and the second node 112 will now be described in further detail with a few non-limiting examples in the next three figures.

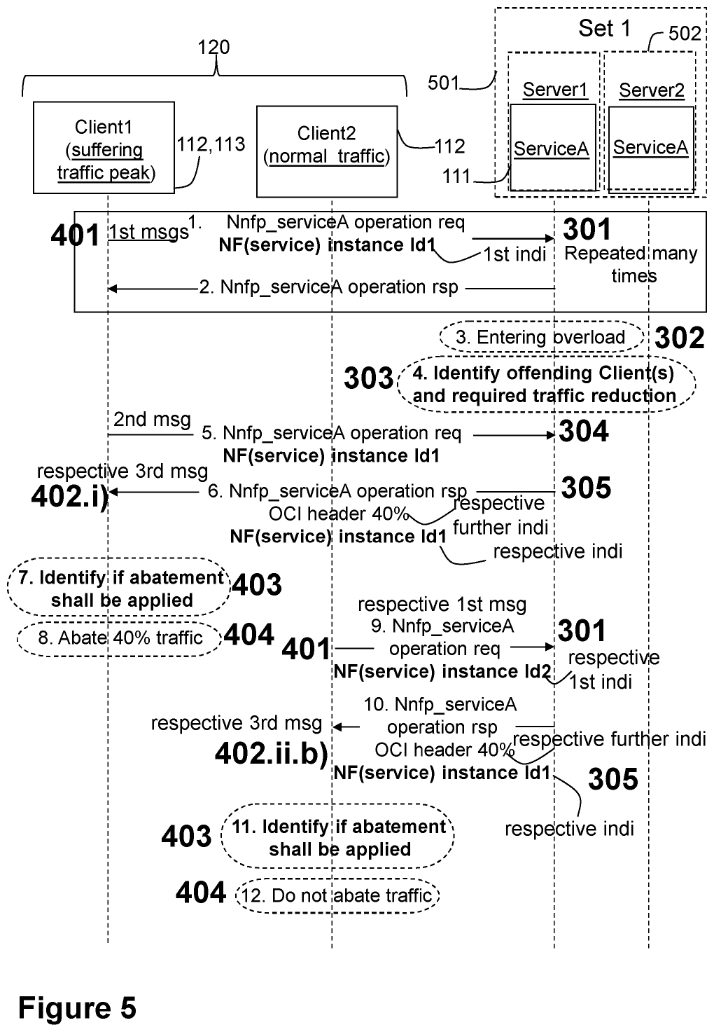

FIG. 5 is a signalling diagram depicting a first non-limiting example of embodiments herein. In this non-limiting example, the group of nodes of the same type 120 comprises two second nodes 112, Client1 and Client2. Client1 may be suffering a traffic peak and may be one of the one or more other nodes 113 which is to abate traffic. Client2 may be a node with normal traffic that may not need to abate traffic. FIG. 5 illustrates a case wherein a traffic peak in Client1 does not affect Client2. The first node 111 is a first server, Server1, providing a first service, Service A. The first node 111 is comprised in a set of servers 501, Set 1, which also comprises a second server 502, Server 2, providing the first service, Service A. The steps of this example are detailed below. In step 1, Client1, in accordance with Action 401, sends one or more first messages to the first node 111, each first message being an Nnfp_serviceA operation req. Each of the one or more first messages, that is, all the service requests, comprise the first indication as Client1's own NF (service) instance Id, here NF(service) instance Id1. The one or more first messages are received by the first node 111 in accordance with Action 301. In step 2, the first node 111 sends back a response to each of the first messages received, as an Nnfp_serviceA operation resp. This is repeated many times. In step 3, the first node 111, in accordance with Action 302, identifies it is entering overload. In step 4, the first node 111, in accordance with Action 303, identifies the offending client(s), by the information provided in the requests. Either by using the User-Agent, or as proposed herein, thanks to the NF(service) instance Id included in all the requests. The first node 111 also determines the required traffic reduction for every offending client. In step 5, the first node 111, in accordance with Action 304, receives the second message from the Client1 as a new Nnfp_serviceA operation req, comprising the NF(service) instance Id as the first indication, that is, NF(service) instance Id1. In step 6, the first node 111, in accordance with Action 305, sends a third message to the Client1 as a Nnfp_serviceA operation resp. In the response, the information of the offending client is included, that is the respective indication, here, as the NF(service) instance Id of Client1, which is NF(service) instance Id1, which is comprised in an OCI header. The third message also comprises the respective further indication indicating that 40% of traffic is to be abated. The Client1 receives the third message in accordance with Action 402.i. In step 7, in accordance with Action 403, based on the information received, Client1 identifies if it has to abate traffic, and if so, by how much according to the respective further indication. Then, it checks whether the User-Agent or the NF(service) instance Id comprised in the third message is its own one. Only if so, it has to abate traffic. In this example, this is the case, so Client1 will abate traffic, as being the offending client. In step 8, Client1, in accordance with Action 404, abates traffic by 40% according to the result of the determination performed in Action 403. In step 9, Client2, in accordance with Action 401, sends a respective first message to the first node 111 as a Nnfp_serviceA operation req, which comprises the respective first indication of the Client2 as the NF(service) instance Id of Client2, here, NF(service) instance Id2. The first node 111 receives the request in agreement with Action 301. In step 10, the first node 111, in accordance with Action 305, sends a respective third message to Client2 as a response to the received request. The first node 111 includes the information of the offending Client, Client1 in this example, in the response as the respective indication. In this example, this corresponds to NF(service) instance Id1. The first node 111 includes the respective indication in an OCI header, which also includes the respective further indication indicating that traffic is to be abated by the identified client by 40%. Client2 receives the respective third message in agreement with Action 402.ii.b). Note that alternatively, the first node 111 may only include the OCI header in the responses to the requests from the offending Client, here Client1. But this may have the constraint that will not be backward compatible, since today if the Overload control mechanism is implemented by a Server, it may have to include the OCI header in all the responses. In step 11, Client2, in accordance with Action 403, based on information received, identifies if it has to abate traffic. Then, it checks whether the User-Agent or the NF(service) instance Id comprised in the received respective third message is its own one. Only if so, it has to abate traffic. In this example, NF(service) instance Id1 does not correspond to Client2, so Client2 determines it is not the, or one of, the offending Client(s), and it has not to abate traffic. In step 12, Client2, in accordance with Action 404, does not abate traffic.

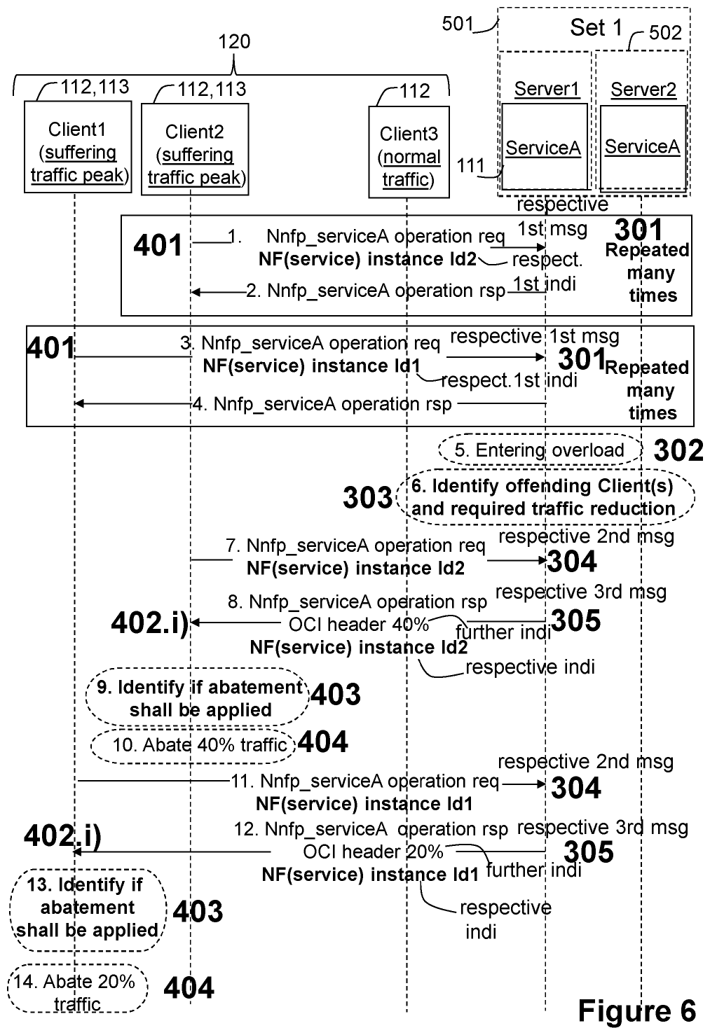

FIG. 6 is a signalling diagram depicting a second non-limiting example of embodiments herein. In this non-limiting example, the group of nodes of the same type 120 comprises three second nodes 112, Client1, Client2 and Client3. Client3 may be a second node 112 with normal traffic that may not need to abate traffic. Client1 and Client 2 may each be suffering a traffic peak and may be two other nodes 113 which are to abate traffic. FIG. 5 illustrates a case there are multiple offending clients. As in the example of FIG. 5, the first node 111 is a first server, Server1, providing the first service, Service A. The first node 111 is comprised in the set of servers 501, Set 1, which also comprises the second server 502, Server 2, providing the first service, Service A. The steps of this example are detailed below. In step 1, Client2, in accordance with Action 401, sends respective one or more first messages to the first node 111, each first message being an Nnfp_serviceA operation req. Each of the respective one or more first messages, that is, all the service requests, comprise the respective first indication as Client2's own NF (service) instance Id, here NF(service) instance Id2. The respective one or more first messages are received by the first node 111 in accordance with Action 301. In step 2, the first node 111 sends back a response to each of the respective one or more first messages received, as an Nnfp_serviceA operation resp. This is repeated many times. A similar description applies to steps 3 and step 4 for Client1, although in this case, all the service requests, comprise the respective first indication as Client1's own NF (service) instance Id, here NF(service) instance Id1. In step 5, the first node 111, in accordance with Action 302, identifies it is entering overload. In step 6, the first node 111, in accordance with Action 303, identifies the offending clients, by the information provided in the requests, thanks to the NF(service) instance Ids included in all the requests. The first node 111 also determines the required traffic reduction for every offending client. In step 7, the first node 111, in accordance with Action 304, receives a respective second message from the Client2 as a new Nnfp_serviceA operation req, comprising the NF(service) instance Id as the first indication, that is, NF(service) instance Id2. In step 8, the first node 111, in accordance with Action 305, sends a respective third message to the Client2 as a Nnfp_serviceA operation resp. In the response, the information of the offending client is included, that is the respective indication, here, as the NF(service) instance Id of Client2, which is NF(service) instance Id2, which is comprised in an OCI header. The third message also comprises the respective further indication indicating that 40% of traffic is to be abated. Client2 receives the respective third message in accordance with Action 402.i. In step 9, in accordance with Action 403, based on the information received, Client2 identifies if it has to abate traffic, and if so, by how much according to the respective further indication. Then, it checks whether the User-Agent or the NF(service) instance Id comprised in the respective third message is its own one. Only if so, it has to abate traffic. In this example, this is the case, so Client2 will abate traffic, as being an offending client. In step 10, Client2, in accordance with Action 404, abates traffic by 40% according to the result of the determination performed in Action 403. In step 11, the first node 111 receives, in agreement with Action 304, a respective second message from Client1 as a Nnfp_serviceA operation req, which comprises the respective first indication of the Client1 as the NF(service) instance Id of Client1, here, NF(service) instance Id1. In step 12, the first node 111, in accordance with Action 305, sends a respective third message to Client1 as a response to the received request. The first node 111 includes the information of the offending Client, Client1 in this example, in the response as the respective indication. In this example, this corresponds to NF(service) instance Id1. The first node 111 includes the respective indication in an OCI header, which also includes the respective further indication indicating that traffic is to be abated by the identified client by 20%. Client1 receives the respective third message in agreement with Action 402.i). In step 13, Client1, in accordance with Action 403, based on information received, identifies if it has to abate traffic. Then, it checks whether the User-Agent or the NF(service) instance Id comprised in the received respective third message is its own one. Only if so, it has to abate traffic. In this example, NF(service) instance Id1 does correspond to Client1, so Client1 determines it is an offending Client, and it has not to abate traffic. It also determines that it has to abate traffic by 20%. In step 14, Client1, in accordance with Action 404, abates traffic by 20%.

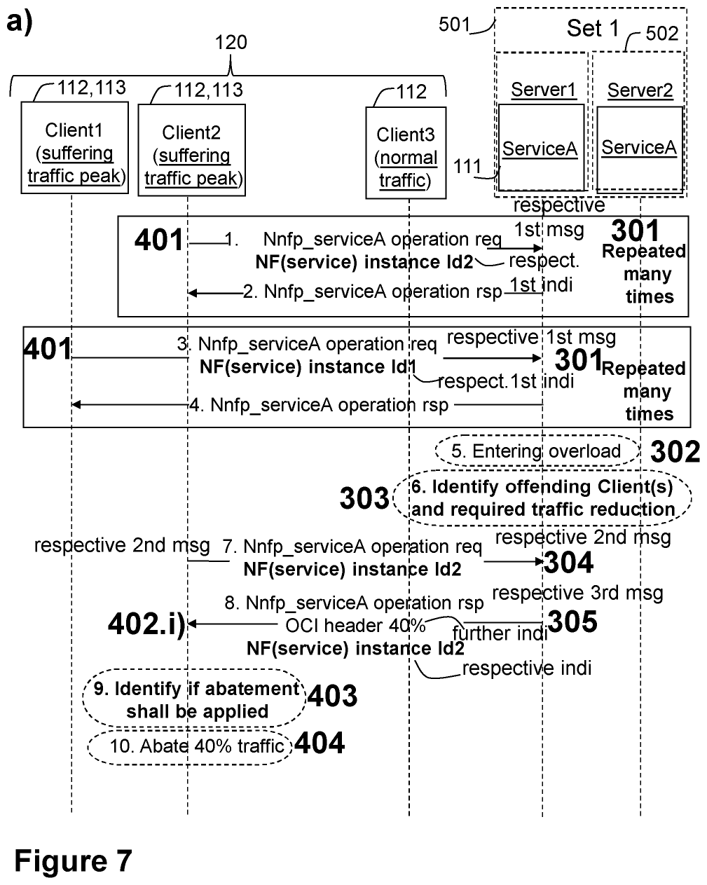

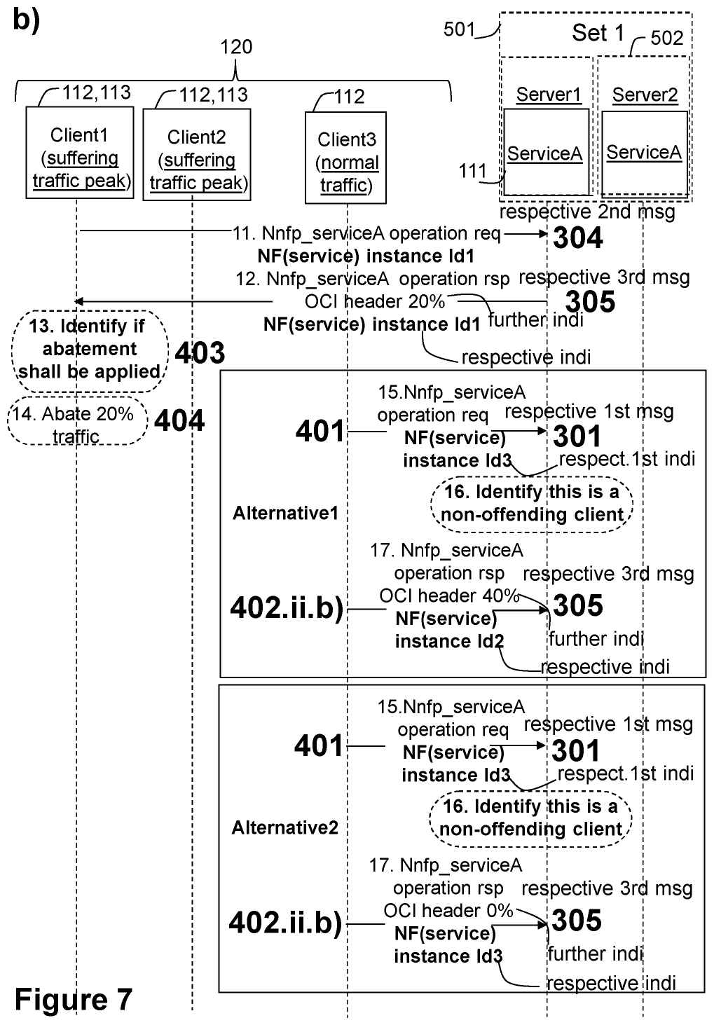

FIG. 7 is a signalling diagram, spread over panel a) and panel b) depicting a third non- limiting example of embodiments herein illustrating another case with multiple offending clients. Steps 1-14 are the same as those described for FIG. 6. Panel b) of FIG. 7, which is a continuation of the method described in panel a), describes two different alternatives for Steps 15-17. In the first alternative, in step 15, Client3, in accordance with Action 401, sends a respective first message to the first node 111 as a Nnfp_serviceA operation req, which comprises the respective first indication of Client3 as the NF(service) instance Id of Client3, here, NF(service) instance Id3. The first node 111 receives the request in agreement with Action 301. In step 16, the first node 111, in accordance with Action 305, identifies Client 3 is a non-offending client. In step 17, the first node 111, in accordance with Action 305, sends a respective third message to Client3 as a response to the received request. The first node 111 includes the information of any of the offending Clients, Client2 in this example, in the response as the respective indication. In this example, this corresponds to NF(service) instance Id2. The first node 111 includes the respective indication in an OCI header, which also includes the respective further indication indicating that traffic is to be abated by the identified client by 40%. Client3 receives the respective third message in agreement with Action 402.ii.b). Although not depicted in the Figure, Client3, may then, in accordance with Action 403, based on information received, identify if it has to abate traffic. Then, it checks whether the User-Agent or the NF(service) instance Id comprised in the received respective third message is its own one. Only if so, it has to abate traffic. In this example, NF(service) instance Id2 does not correspond to Client3, so Client3 determines it is not the, or one of, the offending Client(s), and it does not have to abate traffic. Alternatively, the method may comprise Steps 15-17 according to a second alternative. According to the second alternative, Step 15 and Step 16 may be performed as in Alternative 1. Step 17 of Alternative 2 may comprise that the respective third message sent by the first node 111 may comprise as respective indication the NF(service) instance Id of Client3, a that is, NF(service) instance Id3 2. The first node 111 also includes the respective indication in an OCI header along with the respective further indication indicating that traffic is to be abated by the identified client by zero %. Client3 receives the respective third message in agreement with Action 402.ii.a). Although not depicted in the Figure, Client3, may then, in accordance with Action 403, based on information received, identify if it does not have to abate traffic. Then, it checks whether the User-Agent or the NF(service) instance Id comprised in the received respective third message is its own one. In this example, NF(service) instance Id3 corresponds to Client3, but since the further indication indicates that traffic has to be abated by zero%, Client3 determines that although the respective third message is directed to it, it does not have to abate traffic.

One advantage of embodiments herein is that they enable that traffic abatement is just executed by the second node(s) 112, e.g., client(s), that are actually sending the majority of requests towards the first node 111, e.g., a server. Another advantage of embodiments herein may be that they enable to face traffic peaks in the most efficient way, avoiding requesting other clients to abate traffic, when this may not be necessary.

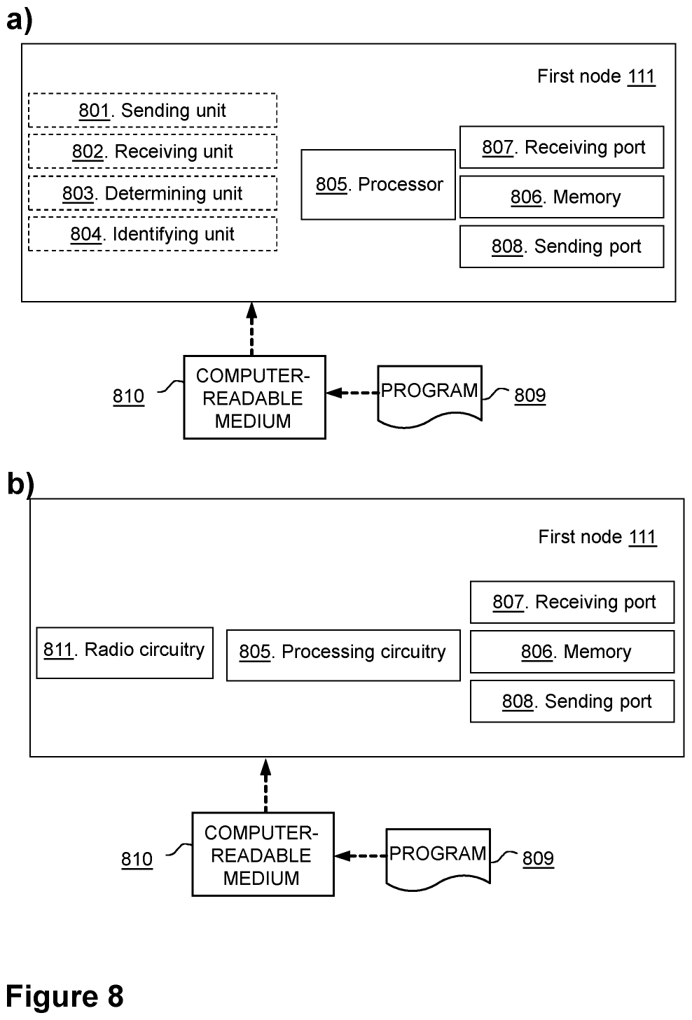

FIG. 8 depicts two different examples in panels a) and b), respectively, of the arrangement that the first node 111 may comprise to perform the method actions described above in relation to FIG. 3, and/or FIGS. 5-7. In some embodiments, the first node 111 may comprise the following arrangement depicted in FIG. 8a. The first node 111 may be understood to be for handling traffic from the second node 112. The first node 111 and the second node 112 are configured to operate in the communications network 100.

Several embodiments are comprised herein. Components from one embodiment may be tacitly assumed to be present in another embodiment and it will be obvious to a person skilled in the art how those components may be used in the other exemplary embodiments. In FIG. 8, optional boxes are indicated by dashed lines. The detailed description of some of the following corresponds to the same references provided above, in relation to the actions described for the first node 111 and will thus not be repeated here. For example, in embodiments wherein the communications network 100 may be configured to be a 5G, network, the first node 111 may be configured to be a server and the second node 112 may be configured to be client of the server.

The first node 111 is configured to, e.g. by means of a sending unit 801 within the first node 111 configured to, send the message, that is, the third message, to the second node 112. The message is configured to comprise the request to abate traffic from the second node 112 to the first node 111. The message is further configured to comprise the indication configured to identify the second node 112, e.g., uniquely identify the second node 112.

In some embodiments, the indication in the message may be further configured to identify the group of nodes of the same type 120 to which the second node 112 may be configured to belong.

The first node 111 may also be configured to, e.g. by means of a receiving unit 802 within the first node 111 configured to, receive the one or more first messages from the second node 112, or from the group of nodes of the same type 120 to which the second node 112 is configured to belong. Each of the one or more first messages may be configured to comprise the first indication configured to identify, e.g., uniquely identify, the sender node. The indication configured to be sent in the message to the second node 112 may be configured to be the second indication configured to be based on the first indication configured to be received.

In some embodiments, the indication and/or the first indication may be configured to be comprised in the HTTP header.

In some embodiments, the first node 111 may be configured to, e.g. by means of a determining unit 803 within the first node 111 configured to, determine, after having received the one or more first messages, that traffic is to be abated.

In some embodiments, the first node 111 may be configured to, e.g. by means of an identifying unit 804 within the first node 111 configured to, identify, based on the first indication configured to be comprised in the one or more first messages configured to be received, that the second node 112 is to abate traffic. The second indication may be configured to be based on the result of the identifying.

The first node 111 may be further configured to, e.g. by means of the receiving unit 802 further configured to, receive, after having identified that the second node 112 is to abate traffic, the second message from the second node 112 configured to comprise the first indication configured to identify, e.g., uniquely identify, the second node 112. The message configured to be sent to the second node 112 may be configured to be the third message and may be configured to be based on the second message configured to be received.

In some embodiments, the message configured to be sent to the second node 112 may be configured to comprise at least one of: a) the further indication of the amount of traffic to be abated, and b) the OCI.

In some embodiments, the indication configured to be sent may be a second indication, and may be configured to be one of: i) the first identifier of the network function instance corresponding to the second node 112, and ii) the second identifier of the network function type of the second node 112.

The embodiments herein may be implemented through one or more processors, such as a processor 805 in the first node 111 depicted in FIG. 8, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 806 comprising one or more memory units. The memory 806 is arranged to be used to store obtained information, store data, configurations, schedulings, and applications etc. to perform the methods herein when being executed in the first node 111.

In some embodiments, the first node 111 may receive information from, e.g., the second node 112, any of the nodes in the group of nodes of the same type 120, and/or any of the one or more other second nodes 113, through a receiving port 807. In some examples, the receiving port 807 may be, for example, connected to one or more antennas in the first node 111. In other embodiments, the first node 111 may receive information from another structure in the communications network 100 through the receiving port 807. Since the receiving port 807 may be in communication with the processor 805, the receiving port 807 may then send the received information to the processor 805. The receiving port 807 may also be configured to receive other information.

The processor 805 in the first node 111 may be further configured to transmit or send information to e.g., the second node 112, any of the nodes in the group of nodes of the same type 120, any of the one or more other second nodes 113, and/or another structure in the communications network 100, through a sending port 808, which may be in communication with the processor 805, and the memory 806.

Those skilled in the art will also appreciate that any of the units 801-804 described above may refer to a combination of analog and digital circuits, and/or one or more processors configured with software and/or firmware, e.g., stored in memory, that, when executed by the one or more processors such as the processor 805, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 801-804 described above may be the processor 805 of the first node 111, or an application running on such processor.

Thus, the methods according to the embodiments described herein for the first node 111 may be respectively implemented by means of a computer program 809 product, comprising instructions, i.e., software code portions, which, when executed on at least one processor 805, cause the at least one processor 805 to carry out the actions described herein, as performed by the first node 111. The computer program 809 product may be stored on a computer-readable storage medium 810. The computer-readable storage medium 810, having stored thereon the computer program 809, may comprise instructions which, when executed on at least one processor 805, cause the at least one processor 805 to carry out the actions described herein, as performed by the first node 111. In some embodiments, the computer-readable storage medium 810 may be a non-transitory computer-readable storage medium, such as a CD ROM disc, a memory stick, or stored in the cloud space. In other embodiments, the computer program 809 product may be stored on a carrier containing the computer program, wherein the carrier is one of an electronic signal, optical signal, radio signal, or the computer-readable storage medium 810, as described above.

The first node 111 may comprise an interface unit to facilitate communications between the first node 111 and other nodes or devices, e.g., the second node 112, any of the nodes in the group of nodes of the same type 120, any of the one or more other second nodes 113, and/or another structure in the communications network 100. In some particular examples, the interface may, for example, include a transceiver configured to transmit and receive radio signals over an air interface in accordance with a suitable standard.

In other embodiments, the first node 111 may comprise the following arrangement depicted in FIG. 8b. The first node 111 may comprise a processing circuitry 805, e.g., one or more processors such as the processor 805, in the first node 111 and the memory 806. The first node 111 may also comprise a radio circuitry 811, which may comprise e.g., the receiving port 807 and the sending port 808. The processing circuitry 805 may be configured to, or operable to, perform the method actions according to FIG. 3, and/or FIGS. 5-7, in a similar manner as that described in relation to FIG. 8a. The radio circuitry 811 may be configured to set up and maintain at least a wireless connection with the second node 112, any of the nodes in the group of nodes of the same type 120, any of the one or more other second nodes 113, and/or another structure in the communications network 100.

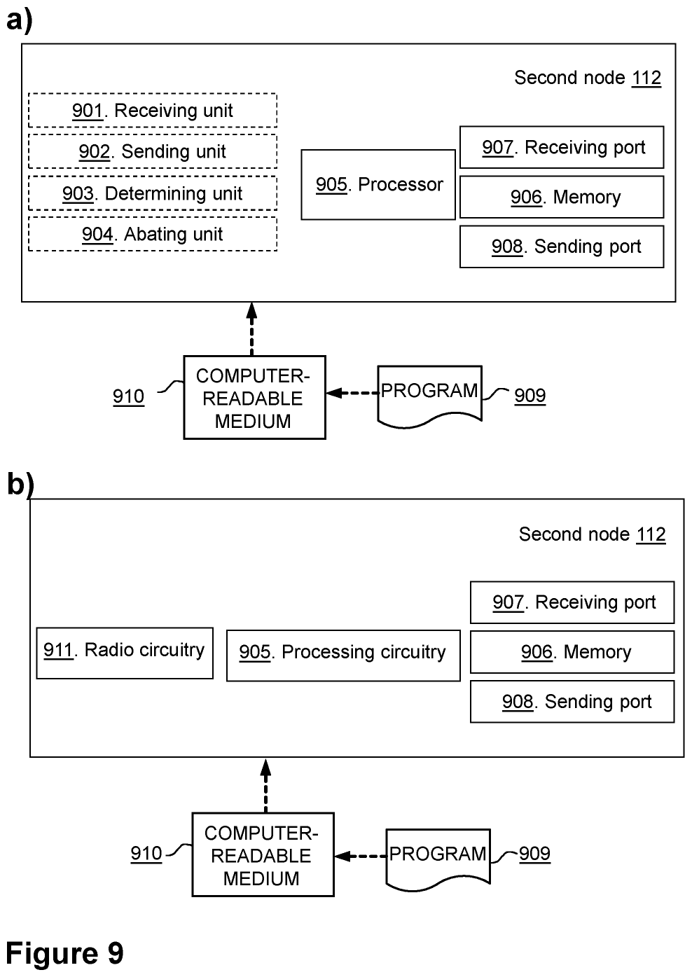

FIG. 9 depicts two different examples in panels a) and b), respectively, of the arrangement that the second node 112 may comprise to perform the method actions described above in relation to FIG. 4, and/or FIGS. 5-7. In some embodiments, the second node 112 may comprise the following arrangement depicted in FIG. 9a. The second node 112 may be understood to be for handling traffic from the second node 112. The second node 112 is configured to operate in the communications network 100.

Several embodiments are comprised herein. Components from one embodiment may be tacitly assumed to be present in another embodiment and it will be obvious to a person skilled in the art how those components may be used in the other exemplary embodiments. In FIG. 9, optional boxes are indicated by dashed lines. The detailed description of some of the following corresponds to the same references provided above, in relation to the actions described for the second node 112 and will thus not be repeated here. For example, in embodiments wherein the communications network 100 may be configured to be a 5G, network, the first node 111 may be configured to be a server and the second node 112 may be configured to be client of the server.

The second node 112 is configured to, e.g. by means of a receiving unit 901 within the second node 112 configured to, receive, the message, that is, the third message, from the first node 111 configured to operate in the communications network 100. The message is configured to comprise the request to abate traffic from the second node 112 to the first node 111 and the indication configured to identify the second node, e.g., uniquely identify the second node.

In some embodiments, the indication may be further configured to identify the group of nodes of the same type 120 to which the second node 112 is configured to belong.

In some embodiments, if no traffic is to be abated, the message may be configured to indicate that zero traffic is to be abated.

In some embodiments, if traffic is to be abated from any one of the second node 112 and the one or more other second nodes 113 operating in the communications network 100, the message is configured to indicate respective traffic to be abated.

In some examples, the message may be configured to comprise one of the following. With the proviso that the second node 112 is to abate traffic, the indication configured to identify, e.g., uniquely identify the second node 112, or the indication further configured to identify the group of nodes of the same type 120 to which the second node 112 is configured to belong. With the proviso that the second node 112 is not to abate traffic and that one or more other second nodes 113 configured to operate in the communications network 100 are to abate traffic, one of the following two options. According to a first option a), the indication configured to identify the second node 112 or, further, the group of nodes of the same type 120 to which the second node 112 is configured to belong. In this first option, the message may be configured to indicate that zero traffic is to be abated. According to a second option, the respective indication configured to identify, e.g., uniquely identify, any of the one or more other second nodes 113 that are to abate traffic, or the second node 112, any of the nodes in the group of nodes of the same type 120, any of the one or more other second nodes 113, and/or another structure in the communications network 100 respective group of nodes of the same type 120 to which the one or more other nodes 113 are configured to belong. In this second option, the message may be configured to indicate that traffic is to be abated.

The second node 112 may also be configured to, e.g. by means of a sending unit 902 within the second node 112 configured to, send the one or more first messages to the first node 111. Each of the one or more first messages may be configured to comprise the first indication configured to identify, e.g., uniquely identify, the second node 112. The indication configured to be received in the message from the first node 111 may be configured to be the second indication configured to be based on the first indication configured to be sent.

In some examples, the first indication may be further configured to identify the group of nodes of the same type 120 to which the second node 112 is configured to belong.

In some embodiments, the indication and/or the first indication may be configured to be comprised in the HTTP header.

In some embodiments, the second node 112 may be configured to, e.g. by means of a determining unit 903 within the second node 112 configured to, determine, based on the indication configured to be comprised in the message configured to be received, whether or not traffic is to be abated.

In some embodiments, the second node 112 may be configured to, e.g. by means of an abating unit 904 within the second node 112 configured to, abate traffic to the first node 111, based on the result of the determination.

In some embodiments, the indication configured to be received may be the second indication, and may be configured to be one of: i) the first identifier of the network function instance corresponding to the second node 112, and ii) the second identifier of the network function type of the second node 112.

In some embodiments, the message configured to be received from the first node 111 may be configured to comprise at least one of: a) the OCI, and b) the further indication of the amount of traffic to be abated.

The embodiments herein may be implemented through one or more processors, such as a processor 905 in the second node 112 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 906 comprising one or more memory units. The memory 906 is arranged to be used to store obtained information, store data, configurations, schedulings, and applications etc. to perform the methods herein when being executed in the second node 112.

In some embodiments, the second node 112 may receive information from, e.g., the first node 111, any of the other nodes in the group of nodes of the same type 120, and/or any of the one or more other second nodes 113 through a receiving port 907. In some examples, the receiving port 907 may be, for example, connected to one or more antennas in the second node 112. In other embodiments, the second node 112 may receive information from another structure in the communications network 100 through the receiving port 907. Since the receiving port 907 may be in communication with the processor 905, the receiving port 907 may then send the received information to the processor 905. The receiving port 907 may also be configured to receive other information.

The processor 905 in the second node 112 may be further configured to transmit or send information to e.g., the first node 111, any of the other nodes in the group of nodes of the same type 120, any of the one or more other second nodes 113, and/or another structure in the communications network 100, through a sending port 908, which may be in communication with the processor 905, and the memory 906.

Those skilled in the art will also appreciate that any of the units 901-904 described above may refer to a combination of analog and digital circuits, and/or one or more processors configured with software and/or firmware, e.g., stored in memory, that, when executed by the one or more processors such as the processor 905, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 901-904 described above may be the processor 905 of the second node 112, or an application running on such processor.

Thus, the methods according to the embodiments described herein for the second node 112 may be respectively implemented by means of a computer program 909 product, comprising instructions, i.e., software code portions, which, when executed on at least one processor 905, cause the at least one processor 905 to carry out the actions described herein, as performed by the second node 112. The computer program 909 product may be stored on a computer-readable storage medium 910. The computer-readable storage medium 910, having stored thereon the computer program 909, may comprise instructions which, when executed on at least one processor 905, cause the at least one processor 905 to carry out the actions described herein, as performed by the second node 112. In some embodiments, the computer-readable storage medium 910 may be a non-transitory computer-readable storage medium, such as a CD ROM disc, a memory stick, or stored in the cloud space. In other embodiments, the computer program 909 product may be stored on a carrier containing the computer program, wherein the carrier is one of an electronic signal, optical signal, radio signal, or the computer-readable storage medium 910, as described above.

The second node 112 may comprise an interface unit to facilitate communications between the second node 112 and other nodes or devices, e.g., the first node 111, any of the other nodes in the group of nodes of the same type 120, any of the one or more other second nodes 113, and/or another structure in the communications network 100. In some particular examples, the interface may, for example, include a transceiver configured to transmit and receive radio signals over an air interface in accordance with a suitable standard.

In other embodiments, the second node 112 may comprise the following arrangement depicted in FIG. 9b. The second node 112 may comprise a processing circuitry 905, e.g., one or more processors such as the processor 905, in the second node 112 and the memory 906. The second node 112 may also comprise a radio circuitry 911, which may comprise e.g., the receiving port 907 and the sending port 908. The processing circuitry 905 may be configured to, or operable to, perform the method actions according to FIG. 4, and/or FIGS. 5-7, in a similar manner as that described in relation to FIG. 9a. The radio circuitry 911 may be configured to set up and maintain at least a wireless connection with the first node 111, any of the other nodes in the group of nodes of the same type 120, any of the one or more other second nodes 113, and/or another structure in the communications network 100.

Hence, embodiments herein also relate to the second node 112 operative for handling traffic from the second node 112, the second node 112 being operative to operate in the communications network 100. The second node 112 may comprise the processing circuitry 905 and the memory 906, said memory 906 containing instructions executable by said processing circuitry 905, whereby the second node 112 is further operative to perform the actions described herein in relation to the second node 112, e.g., in FIG. 4, and/or FIGS. 5-7.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCE

3GPP TS 29.500 v17.1.0 5G System; Technical Realization of Service Based Architecture; Stage 3.

1-38. (canceled)

39. A method performed by a first node, the method being for handling traffic from a second node, the first node and the second node operating in a communications network, the method comprising:
sending a message to the second node, the message comprising a request to abate traffic from the second node to the first node, the message further comprising an indication identifying the second node.

40. The method of claim 39, wherein the indication in the message further identifies a group of nodes of a same type to which the second node belongs.

41. The method of claim 39, further comprising:
receiving one or more first messages from the second node, or from a group of nodes of the same type to which the second node belongs, each of the one or more first messages comprising a first indication identifying the sender node, and wherein the indication sent in the message to the second node is a second indication based on the received first indication.

42. The method of claim 41, wherein the indication and/or the first indication is comprised in a Hypertext Transfer Protocol (HTTP) header.

43. The method of 41, further comprising:
determining, after having received the one or more first messages, that traffic is to be abated; and
identifying, based on the first indication comprised in the received one or more first messages, that the second node is to abate traffic, wherein the second indication is based on a result of the identifying.

44. The method of claim 43, further comprising:
receiving, after having identified that the second node is to abate traffic, a second message from the second node, comprising the first indication identifying the second node and wherein the message sent to the second node is a third message and is based on the received second message.

45. The method of claim 39, wherein the sent message to the second node comprises at least one of a further indication of an amount of traffic to be abated and an Overload Control Information (OCI).

46. The method of claim 39, wherein the sent indication is a second indication, and is one of a first identifier of a network function instance corresponding to the second node and a second identifier of a network function type of the second node.

47. The method of claim 39, wherein the communications network is a 5G, network, and wherein the first node is a server and the second node is a client of the server.

48. A method, performed by a second node, the method being for handling traffic from the second node, the second node operating in a communications network, the method comprising:
receiving a message from a first node operating in the communications network, the message comprising a request to abate traffic from the second node to the first node, and an indication identifying the second node.

49. The method of claim 48, wherein the indication in the message further identifies a group of nodes of a same type to which the second node belongs.

50. The method of claim 48, wherein if no traffic is to be abated, the message indicates that zero traffic is to be abated.

51. The method of claim 48, wherein if traffic is to be abated from any one of the second node and one or more other second nodes operating in the communications network, the message indicates respective traffic to be abated.

52. The method of claim 48, further comprising:
sending one or more first messages to the first node, each of the one or more first messages comprising a first indication identifying the second node, and wherein the indication received in the message from the first node is a second indication based on the sent first indication.

53. The method of claim 52, wherein the indication and/or the first indication is comprised in a Hypertext Transfer Protocol, HTTP, header.

54. The method of claim 48, further comprising:
determining, based on the indication comprised in the received message, whether or not traffic is to be abated; and
abating traffic to the first node, based on a result of the determination.

55. The method of claim 48, wherein the received indication is a second indication, and is one of a first identifier of a network function instance corresponding to the second node an a second identifier of a network function type of the second node.

56. The method of claim 48, wherein the message received from the first node comprises at least one of an Overload Control Information (OCI) and a further indication of an amount of traffic to be abated.

57. A first node, for handling traffic from a second node, the first node and the second node being configured to operate in a communications network, the first node comprising:
processing circuitry and memory, the memory containing instructions executable by the processing circuitry whereby the first node is further configured to:
send a message to the second node, the message being configured to comprise a request to abate traffic from the second node to the first node, the message being further configured to comprise an indication configured to identify the second node.

58. A second node, for handling traffic from the second node, the second node being configured to operate in a communications network, the second node being comprising:
processing circuitry and memory, the memory containing instructions executable by the processing circuitry whereby the second node is further configured to:
receive a message from a first node configured to operate in the communications network, the message being configured to comprise a request to abate traffic from the second node to the first node, and an indication configured to identify the second node.
